(19) United States
(12) Patent Application Publication
(10) Pub. No.: US 2014/0160101 A1
(43) Pub. Date: Jun. 12, 2014

(54) DISPLAY WALL ADJUSTING APPARATUS AND METHOD FOR ADJUSTING DISPLAY PARAMETERS OF DISPLAY SCREENS OF DISPLAY WALL

(71) Applicant: HON HAI PRECISION INDUSTRY CO., LTD., New Taipei (TW)

(72) Inventors: CHUN-MING CHEN, New Taipei (TW); YI-WEN CAI, New Taipei (TW); CHUNG-I LEE, New Taipei (TW)

(73) Assignee: HON HAI PRECISION INDUSTRY CO., LTD., New Taipei (TW)

(21) Appl. No.: 14/098,547

(22) Filed: Dec. 6, 2013

(30) Foreign Application Priority Data
Dec. 10, 2012 (TW) 101146477

(51) Int. Cl. G06F 3/00; G06T 7/00

(52) U.S. Cl. CPC G06F 3/005; G06T 7/0002
USPC 345/207

(57) ABSTRACT

A display wall adjusting apparatus and a method for adjusting display parameters of display screens of a display wall. The display wall adjusting apparatus includes an image sensing unit and a control unit. The image sensing unit captures image(s) of the display screens. The control unit analyzes the image(s) to obtain an actual display parameter of each of the display screens, and produces control information according to the actual display parameters of the display screens. The display wall adjusting device transmits the control information to the display wall, such that the display parameters of the display wall can be adjusted according to the control information, and the display parameters of the individual display screens are synchronized.

### BACKGROUND

1. Technical Field

The present disclosure relates to a display wall with a plurality of display screens, and particularly to a display wall adjusting apparatus and method for adjusting display parameters of the display screens of the display wall.

2. Description of Related Art

Display walls with a plurality of display screens are often used to display multiple images. However, the display screens may not display the images identically because of differences in display parameters and/or components of the display screens. Since it is difficult to detect inaccuracy of displays using the naked eye, specific measuring devices with photo diodes are generally used, which is inconvenient for users without the specific measuring devices.

### BRIEF DESCRIPTION OF THE DRAWINGS

Many aspects of the present disclosure can be better understood with reference to the drawings. The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of a first embodiment of a display wall adjusting system of the present disclosure.

FIG. 2 is a block diagram of a second embodiment of the display wall adjusting system of FIG. 1.

FIG. 3 and FIG. 4 are a flowchart of an embodiment of a method for adjusting display parameters of display screens of a display wall.

### DETAILED DESCRIPTION

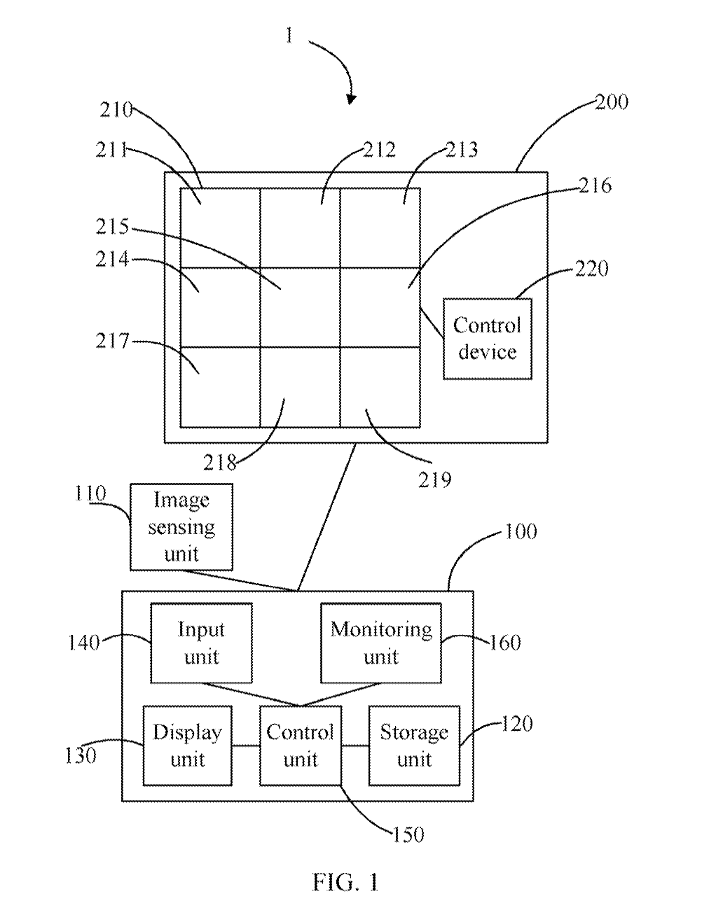

FIG. 1 is a block diagram of a first embodiment of a display wall adjusting system 1. The display wall adjusting system 1 comprises a display wall adjusting apparatus 100, an image sensing unit 110, and a display apparatus 200. The display wall adjusting apparatus 100 communicates with the display apparatus 200 through a wired network or a wireless network. The display wall adjusting apparatus 100 communicates with the image sensing unit 110 through a wired network (e.g. a coaxial cable), a wireless network. The wireless network can be a short distance wireless network, such as the BLUETOOTH telecommunication standard.

The display apparatus 200 comprises a display wall 210 comprising display screens 211-219, and a control device 220. The control device 220 comprises graphics card(s) to control the display wall 210 to display one or more images individually through one of the display screens 211-219, or to display an image jointly through a portion or all of the display screens 211-219. Each display screen 211-219 is configured according to a display parameter to display images. The display parameter can represent color, contrast, white balance, sharpness, grayscale, brightness, or other type of display variable of each of the display screens 211-219.

In the illustrated embodiment, the display wall adjusting apparatus 100 transmits a display information Id (not shown) to the display apparatus 200, thereby enabling each display screen 211-219 to display a test image according to the display information Id. The test image is an image suitable for obtaining an actual display parameter Pd (not shown) of each display screen 211-219. For instance, if the display parameter represents the brightness of each display screen 211-219, the test image can be an all-white image, such that the actual brightness of each display screen 211-219 can be obtained.

The image sensing unit 110 can be a camera that is fixed to a structure (e.g. a wall) or movable along a track. The image sensing unit 110 is used to capture images of the display screens 211-219 at different angles. In the illustrated embodiment, the image sensing unit 110 captures one or more images of each of the display screens 211-219. In other embodiments, the image sensing unit 110 captures one or more images of an overall view of all the display screens 211-219. To capture the one or more images at different angles, a plurality of the image sensing units 110 can be used.

The display wall adjusting apparatus 100 is a monitoring device that comprises a storage unit 120, a display unit 130, an input unit 140, and a control unit 150. In the embodiment, the monitoring device is a video monitor to monitor a space. The space can be preset or set by the user. The storage unit 120 is used to store the one or more images captured by the image sensing unit 110. The storage unit 120 can comprise a storage device such as a random access memory, a non-volatile memory, or a hard disk drive. The display unit 130 can be a display device such as a liquid crystal display (LCD). In the illustrated embodiment, the display unit 130 is controlled by the control unit 150 to display the one or more images captured by the image sensing unit 110. The input unit 140 can comprise an input device such as a touch panel. A user can use the input unit 140 to issue a capturing instruction for enabling the image sensing unit 110 to capture the one or more images of the display screens 211-219. The user can also use the input unit 140 to set a predetermined time interval for capturing images of the display screens 211-219. The image sensing unit 110 captures images of the display screens 211-219 per the predetermined time interval.

The control unit 150 controls the image sensing unit 110 to capture images of the display screens 211-219 at the different angles. The control unit 150 analyzes the captured images to obtain the actual display parameter Pd of each of the display screens 211-219.

In the illustrated embodiment, once the image sensing unit 110 captures an image of the display screens 211-219, the control unit 210 immediately analyzes the captured image. In other embodiments, after the image sensing unit 110 captures a plurality of images of the display screens 211-219 at different angles, the control unit 210 selects an image to analyze according to a selection method. The selection method can be selecting an image at random, selecting an image in a predetermined sequence, or selecting a best image that is clearest and most comprehensive of the captured images.

In the illustrated embodiment, the display parameter of each of the display screens 211-219 is set to a same initial value before the one or more images of the display screens 211-219 are captured. The initial value can be preset or set by the user. After the one or more images of the display screens 211-219 are captured, the actual display parameter Pd of each of the display screens 211-219 is obtained by analyzing the captured images.

The control unit 150 further produces control information Ic (not shown) according to the actual display parameters Pd of the display screens 211-219. The control information Ic can comprise configuration information for adjusting the display parameters of the display screens 211-219. In the illustrated embodiment, the control unit 150 determines a standard display parameter Ps (not shown) according to the actual display parameters Pd of the display screens 211-219. The control unit 150 produces the control information Ic according to a difference between the actual display parameter Pd of each of the display screens 211-219 and the standard display parameter Ps, such that the display apparatus 200 can compensate for any difference between the actual display parameters Pd of the display screens 211-219 and the standard display parameter Ps.

For instance, when the actual display parameter Pd represents the brightness of one of the display screens 211-219, the control unit 150 produces the control information Ic for increasing the brightness of the corresponding display screen 211-219 when the brightness is lower than the brightness represented by the standard display parameter Ps, or produces the control information Ic for decreasing the brightness of the corresponding display screen 211-219 when the brightness is higher than the brightness represented by the standard display parameter Ps.

In the illustrated embodiment, the control unit 150 automatically sets the standard display parameter Ps as a minimum value of the actual display parameters Pd of the display screens 211-219. For example, when the actual display parameter Pd represents the brightness of the display screens 211-219, the control unit 150 sets the standard display parameter Ps as the lowest level of brightness displayed by the display screens 211-219. In other embodiments, the control unit 150 sets the standard display parameter Ps as an average value of the actual display parameters Pd, or sets the standard display parameter Ps manually through the input unit 140 by the user.

The display wall adjusting apparatus 100 transmits the control information Ic to the display apparatus 200. The control device 220 adjusts the display parameter of each display screen 211-219 according to the control information Ic, thereby compensating for any difference between the display parameter of each display screen 211-219 and the standard display parameter Ps.

After the actual display parameters Pd of the display screens 211-219 are equalized, the actual display parameters Pd of the display screens 211-219 are synchronized. In addition, the actual display parameters Pd of the display screens 211-219 are verified by determining whether the actual display parameters Pd of the display screens 211-219 are all equal to the standard display parameter Ps. If one or more actual display parameters Pd of the display screens 211-219 are not equal to the standard display parameter Ps, the control unit 150 adjusts the actual display parameters Pd of the one or more display screens 211-219 to enable the actual display parameters Pd of the display screens 211-219 to be synchronized. For instance, if an actual display parameter Pd of the display screen 211 is not equal to the standard display parameter Ps, the control unit 150 adjusts the actual display parameter Pd of the display screen 211 to enable the display parameters of the display screens 211-219 to be synchronized.

The display wall adjusting apparatus 100 further comprises a monitoring unit 160. The monitoring unit 160 can be a software module, such as a central management system. The monitoring unit 160 controls the image sensing unit 110 to monitor the space of the monitoring device while the image sensing unit 110 is not capturing the images. When the image sensing unit 110 needs to capture the images, the image sensing unit 110 is controlled by the control unit 150 to capture images of the display screens 211-219. When the display wall adjusting apparatus 100 comprises a plurality of the image sensing units 110, one or more image sensing units 110 can be used to capture images of the display screens 211-219 while other image sensing units 110 monitor different spaces.

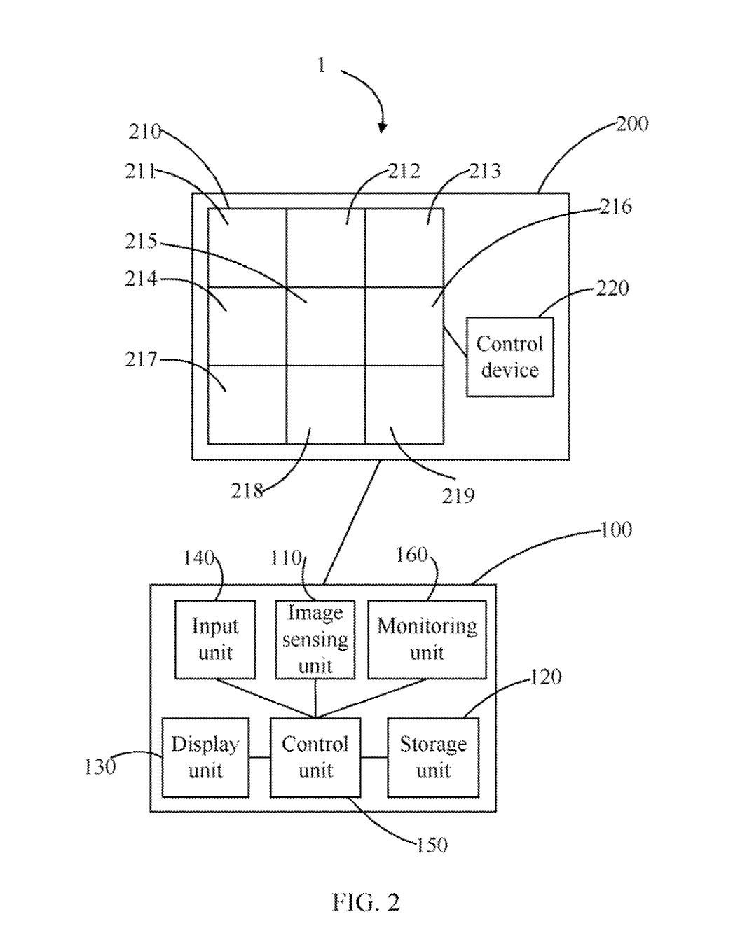

FIG. 2 is a block diagram of a second embodiment of the display wall adjusting system 1 of FIG. 1. The image sensing unit 110 is integrated in the display wall adjusting apparatus 100, and other connections are the same as those in FIG. 1. The image sensing unit 110 can comprise a camera that can be, but is not limited to be, a charge-coupled device (CCD) or complementary metal-oxide semiconductor (CMOS) image sensors.

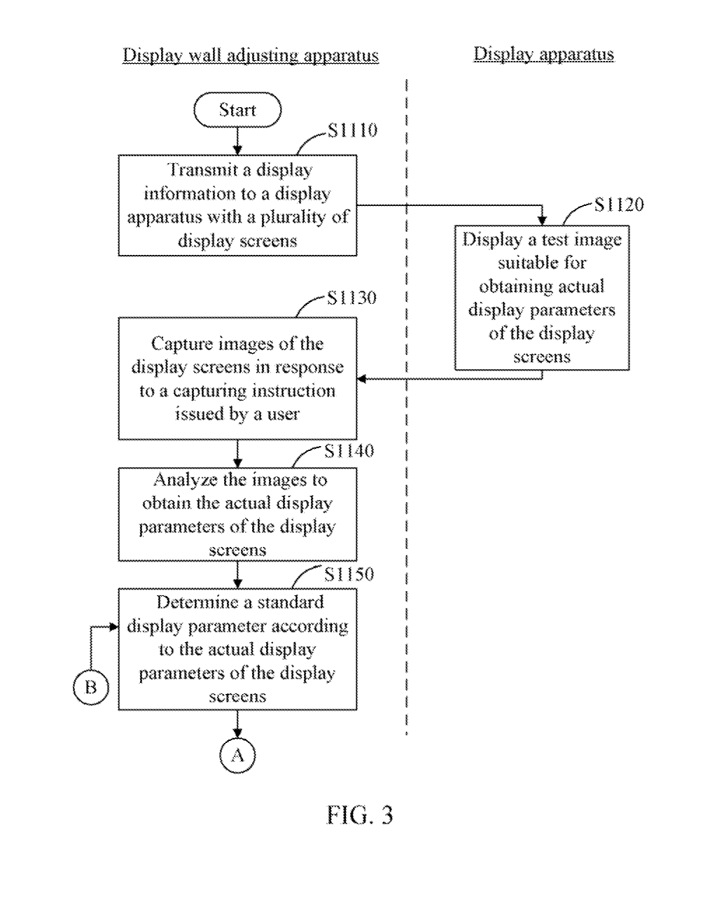

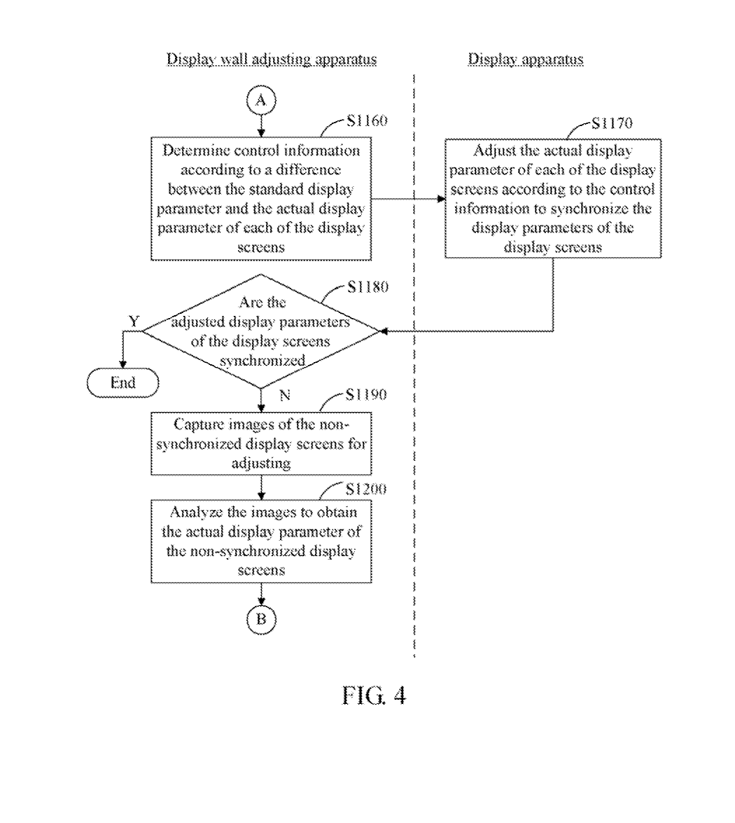

FIG. 3 and FIG. 4 are a flowchart of an embodiment of a method for adjusting display parameters of the display screens 211-219 of the display wall 210. The method is implemented by execution of computer-readable program codes or instructions stored in the storage unit 120 and executed by at least one processor (i.e., the control unit 150) of the display wall adjusting apparatus 100. Depending on the embodiment, additional steps may be added, others removed, and the ordering of the steps may be changed.

In step S1110, the display information Id is transmitted to the display apparatus 200 with the display screens 211-219. The display screens 211-219 can display one or more images individually or jointly.

In step S1120, a test image suitable for obtaining actual display parameters Pd of the display screens 211-219 is displayed on the display screens 211-219. In the illustrated embodiment, the actual display parameter Pd represents the brightness of each of the display screens 211-219. In other embodiments, the actual display parameter Pd can represent the color, the contrast, the white balance, the sharpness, the grayscale, or other types of display parameters.

In step S1130, the one or more images of the display screens 211-219 are captured in response to the capturing instruction issued by the user. In the illustrated embodiment, the one or more images of each of the display screens 211-219 are captured. In other embodiments, the one or more images of a full or overall view of all the display screens 211-219 can be captured.

In step S1140, the captured images are analyzed to obtain the actual display parameters Pd of the display screens 211-219.

In step S1150, the standard display parameter Ps is determined according to the actual display parameters Pd of the display screens 211-219. In the illustrated embodiment, the minimum value of the actual display parameters Pd of the display screens 211-219 is set as the standard display parameter Ps.

In step S1160, the control information Ic is determined according to a difference between the standard display parameter Ps and the actual display parameter Pd of each of the display screens 211-219.

In step S1170, the actual display parameter Pd of each of the display screens 211-219 is adjusted according to the control information Ic, thereby synchronizing the display parameters of the display screens 211-219.

In step S1180, the control unit 150 determines whether the adjusted display parameters of the display screens 211-219 are synchronized. If the adjusted display parameters of the display screens 211-219 are not synchronized, step S1190 is implemented. Otherwise, the method is terminated. In the illustrated embodiment, the control unit 150 determines whether the adjusted display parameters are equal to the standard display parameter Ps. If the adjusted display parameters are all equal to the standard display parameter Ps, the adjusted display parameters of the display screens 211-219 are synchronized. If one or more adjusted display parameters are not equal to the standard display parameter Ps, the adjusted display parameters of the display screens 211-219 are not synchronized.

In step S1190, one or more images of the non-synchronized display screens 211-219 are captured for adjusting the actual display parameters Pd of the non-synchronized display screens 211-219.

In step S1200, the captured images are analyzed to obtain the actual display parameter Pd of the one or more non-synchronized display screens 211-219, and the procedure returns to step S1150.

In the display wall adjusting device and the display wall adjusting method, since the actual display parameters Pd of the display screens 211-219 are adjusted to match the standard display parameter Ps according to the control information Ic, the actual display parameters Pd of the display screens are synchronized. Furthermore, the monitoring device is used to adjust the actual display parameters Pd of the display screens 211-219, which improves efficiency without using specific measuring devices.

While the disclosure has been described by way of example and in terms of preferred embodiment, the disclosure is not limited thereto. On the contrary, it is intended to cover various modifications and similar arrangements as would be apparent to those skilled in the art. Therefore the range of the appended claims should be accorded the broadest interpretation so as to encompass all such modifications and similar arrangements.

What is claimed is:

1. A display wall adjusting apparatus communicating with a display wall, the display wall comprising a plurality of display screens, the display wall adjusting apparatus comprising:
an image sensing unit;
a control unit;
a storage unit storing one or more programs, which when executed by the control unit, causes the control unit to:
control the image sensing unit to capture one or more images corresponding to the display screens of the display wall, wherein the display wall selectively displays one or more images individually and jointly through at least a portion of the display screens;
analyze the one or more images to obtain a display parameter of each of the display screens, and produce control information according to the display parameters of the display screens; and
transmit the control information to the display wall, and enable the display wall to adjust the display parameter of at least one of the display screens according to the control information to substantially synchronize the display parameters of the display screens.

2. The display wall adjusting apparatus of claim 1, wherein the control information is produced by performing steps of:
determining a standard display parameter according to the display parameters of the display screens; and
producing the control information according to a difference between the display parameter of each of the display screens and the standard display parameter.

3. The display wall adjusting apparatus of claim 2, wherein the standard display parameter corresponds to the minimum value of the display parameters of the display screens.

4. The display wall adjusting apparatus of claim 1, wherein the one or more programs further causes the control unit to:
transmit a display information to the display wall, and enable at least a portion of the display screens of the display wall to display a test image corresponding to the display parameter according to the display information.

5. The display wall adjusting apparatus of claim 1, wherein the image sensing unit captures images of the display screens of the display wall at different angles.

6. The display wall adjusting apparatus of claim 1, wherein the image sensing unit captures the one or more images corresponding to a full view of the display screens of the display wall.

7. The display wall adjusting apparatus of claim 1, wherein the display parameter is one of brightness, color, contrast, white balance, sharpness, and grayscale of each of the display screens.

8. The display wall adjusting apparatus of claim 1, further comprising a monitoring unit for controlling the image sensing unit to monitor a space when the image sensing unit is not capturing the images.

9. The display wall adjusting apparatus of claim 8, further comprising a plurality of image sensing units that capture images of the display screens when the image sensing units are controlled by the monitoring unit to monitor different spaces.

10. A method for adjusting display parameters of display screens of a display wall, the display wall being connected to a display wall adjusting apparatus, the method comprising:
controlling an image sensing unit of the display wall adjusting apparatus to capture one or more images corresponding to the display screens of the display wall, wherein the display wall selectively displays one or more images individually and jointly through at least a portion of the display screens;
analyzing the one or more images to obtain a display parameter of each of the display screens, and producing control information according to the display parameters of the display screens; and
transmitting the control information to the display wall, and enabling the display wall to adjust the display parameter of at least one of the display screens according to the control information to substantially synchronize the display parameters of the display screens.

11. The method as described in claim 10, wherein the step of producing the control information comprises:
determining a standard display parameter according to the display parameters of the display screens; and
producing the control information according to a difference between the display parameter of each of the display screens and the standard display parameter.

12. The method as described in claim 11, wherein the step of determining the standard display parameter comprises:
determining the standard display parameter to correspond to the minimum value of the display parameters of the display screens.

13. The method as described in claim 10, further comprising:
transmitting a display information to the display wall, and enabling at least a portion of the display screens of the display wall to display a test image corresponding to the display parameter according to the display information.

14. The method as described in claim 10, wherein the step of capturing the one or more images comprises:
controlling the image sensing unit to capture images of the display screens of the display wall at different angles.

15. The method as described in claim 10, wherein the step of capturing the one or more images comprises:
capturing the one or more images corresponding to a full view of the display screens of the display wall.

16. The method as described in claim 10, wherein the display parameter is one of brightness, color, contrast, white balance, sharpness, and grayscale of each of the display screens.

17. The method as described in claim 10, further comprising:
controlling the image sensing unit to monitor a space by a monitoring unit of the display wall adjusting apparatus when the image sensing unit is not capturing the images.

18. The method as described in claim 17, further comprising:
controlling one or more image sensing units of the display wall adjusting device to capture images of the display screens of the display wall when the image sensing units are controlled by the monitoring unit to monitor different spaces.
